(19) United States
(12) Patent Application Publication
(10) Pub. No.: US 2023/0397682 A1
(43) Pub. Date: Dec. 14, 2023

(54) EYELASH EXTENSION AND METHOD OF MANUFACTURING SAME

(71) Applicant: Kiss Nail Products, Inc., Port Washington, NY (US)

(72) Inventors: Kyu Sang Han, Glen Head, NY (US); Kichul Ahn, Plainview, NY (US)

(21) Appl. No.: 18/250,744

(22) PCT Filed: Sep. 28, 2021
(86) PCT No.: PCT/US2021/052415

§ 371 Date: Apr. 26, 2023

Related U.S. Application Data
(60) Provisional application No. 63/084,916, filed on Sep. 29, 2020.

(51) Int. Cl. A41G 5/02

(52) U.S. Cl. CPC A41G 5/02

(57) ABSTRACT

A method of manufacturing an eyelash extension system having the steps: providing a set of eyelash extensions onto a stage, wherein the eyelash extension system has eyelash filaments extending from a laterally facing surface of an eyelash support strip; and; pushing an adhesive element out of a tape assembly and onto a medially facing surface of an eyelash support strip using a pushing plate. An eyelash extension system having an eyelash support strip having a laterally facing surface and a medially facing surface; and an adhesive element fixed to the medially facing surface.

### PRIORITY CLAIM

The instant application is a U.S. national phase application of PCT application No. PCT/US21/52451 filed on Sep. 28, 2021 that claims priority to U.S. provisional application Ser. No. 63/084,916, filed on Sep. 29, 2020, the contents of both of which are incorporated by reference.

### BACKGROUND OF THE INVENTION

### 1. Field of the Invention

The field of the invention is an eyelash extension system and method for manufacturing same and, more particularly but not exclusively, artificial lashes having a pre-applied adhesive element.

### 2. Background of the Invention

Artificial eyelash extension systems are well-known products used to improve the look of a user's natural lash line through the addition of lash length and/or volume. Such artificial eyelash extension systems typically comprise a lash line support strip with eyelash filaments extending therefrom. The filaments can be made from mink, synthetic materials, horsehair, and in some instances, human hair. Artificial eyelash extension systems are normally applied by applying adhesive to or near the lash line support strip of a lash extension system and pressing the lash line support strip to a user's lash line or proximate thereto. Standard eyelash extension systems can be challenging to apply and require that a user have both the extension systems and specialized adhesives at hand to use them.

More recently, do-it-yourself, under-lash eyelash extension systems have been developed. In these systems, an eyelash extension system is glued to the underside of a user's natural eyelashes in a similar fashion to more traditional above-lash extension systems. The do-it-yourself systems often come in small sections, allowing for an inexperienced user to apply the eyelash extension systems without the difficulty of aligning a longer, single strip of eyelash extension systems. However, these do-it-yourself systems still require users to apply specialty adhesive to their lashes or the lash extension system before use.

A need exists in the art for eyelash extension systems that eliminate the difficulties of prior art systems. A need also exists for a manufacturing method to generate those eyelash extension systems.

### SUMMARY OF INVENTION

An object of the invention is to create eyelash extension systems that overcome many of the drawbacks in the prior art. A feature of the invention is that the eyelash extension system has pre-applied adhesive elements. An advantage of the invention is that the eyelash extension system is ready to use without the application of additional adhesive.

A further object of the invention is to provide a method of manufacturing a ready-to-use eyelash extension system having pre-applied adhesive. A feature of the invention is the use of monoliths extending from a platform to hold naked eyelash extension systems in place while receiving adhesive. An advantage of the invention is that the invented manufacturing method allows for delicate adhesives to be applied to delicate lash extension systems without damaging either.

Another object of the invention is to provide a method of manufacturing ready-to-use eyelash extension systems using double-sided tape or similar adhesive elements as the pre-applied adhesive. A feature of the invention is using adhesive elements having cutouts along the lengths of the adhesives. An advantage of the invention is the cutouts provide the ability to apply double-sided tape or similar adhesive elements to naked eyelash extension systems without the tape becoming twisted, tangled, or having entrained air bubbles.

Another object of the invention is to provide a method of manufacturing ready-to-use eyelash extension systems using pre-glue as the pre-applied adhesive. A feature of the invention is using a release coating to allow the lash extension systems to be easily removed from the assembly. An advantage of the invention is to reduce the thickness of the lash assembly and remove the risk of the adhesive tape from becoming twisted, tangled, or having entrained air bubbles.

The invention provides a method of manufacturing an eyelash extension system comprising: providing an eyelash extension system onto a stage, wherein the eyelash extension system comprises eyelash filaments extending from a laterally facing surface of an eyelash support strip; and pushing an adhesive element out of a tape assembly and onto a medially facing surface of the eyelash support strip using a pushing plate.

Also provided is an eyelash extension system comprising: an eyelash support strip having a laterally facing surface and a medially facing surface; and an adhesive element fixed to the medially facing surface.

Also provided is a method of manufacturing an eyelash extension system comprising: providing one or more eyelash extension systems onto a stage, wherein the eyelash extension system comprises eyelash filaments extending from a laterally facing surface of an eyelash support strip; and attaching an adhesive element from a pre-glue assembly to a medially facing surface of the eyelash support strip by using a pushing plate and/or a plurality of retaining members.

### BRIEF DESCRIPTION OF THE DRAWINGS

The invention, together with the above and other objects and advantages, will be best understood from the following detailed description of the preferred embodiment of the invention shown in the accompanying drawings, wherein:

FIG. 1 is a perspective view of an eyelash extension system having a pre-applied adhesive element in accordance with the features of the present invention;

FIG. 2A is a perspective view of an adhesive element having cutouts in accordance with the features of the present invention;

FIGS. 2B-2G are plan views of alternative adhesive elements having cutouts in accordance with the features of the present invention;

FIG. 3 is an exploded view of the manufacturing setup to manufacture an eyelash extension system having a pre-applied adhesive tape in accordance with the features of the present invention;

FIG. 4 is a detailed view of a stage for receiving and stabilizing a lash extension system to receive an adhesive in accordance with the features of the present invention;

FIGS. 5A-5C are cross-sectional views of an eyelash extension system engaged with the stage for receiving same in accordance with the features of the present invention;

FIGS. 6A-6B are detailed views of an assembly used to apply an adhesive to a lash extension system in accordance with the features of the present invention;

FIG. 7 is a detailed view of a pushing assembly used to push an adhesive onto a lash extension system in accordance with the features of the present invention;

FIG. 8 is a cross-section view of a finished lash extension system having a pre-applied adhesive manufactured according to the features of the present invention;

FIG. 9 is a schematic for a method to create adhesive elements according to the features of the present invention;

FIG. 10 is an exploded view of the manufacturing setup to manufacture an eyelash extension system having a pre-applied pre-glue adhesive in accordance with the features of the present invention;

FIG. 11 is a front view of the pre-glue assembly; and

FIGS. 12A-12B are a front view and cross-sectional view, respectively, of the completed lash extension system and pre-glue assembly using the pre-glue manufacturing method.

### DETAILED DESCRIPTION OF THE INVENTION

In various embodiments, the invention provides a ready-to-apply eyelash extension system. The eyelash extension system comprises lash filaments extending from an eyelash support strip wherein the eyelash support strip features an adhesive element disposed thereon for attachment to the eyelid and/or natural lashes of a user.

The invention also provides a method of manufacturing a ready-to-apply eyelash extension system. The method of manufacturing comprises providing an eyelash extension onto a holding assembly and pressing an adhesive onto the eyelash extension system.

The foregoing summary, as well as the following detailed description of certain embodiments of the present invention, will be better understood when read in conjunction with the appended drawings.

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property. The phrases “lash,” “artificial eyelash,” and “eyelash,” as used herein, are interchangeable and refer to an apparatus that is not part of the wearer's body unless specifically indicated otherwise (e.g., phrases such as “natural eyelash” or “user's eyelash” refer to a part of the wearer's body).

Extension System Detail

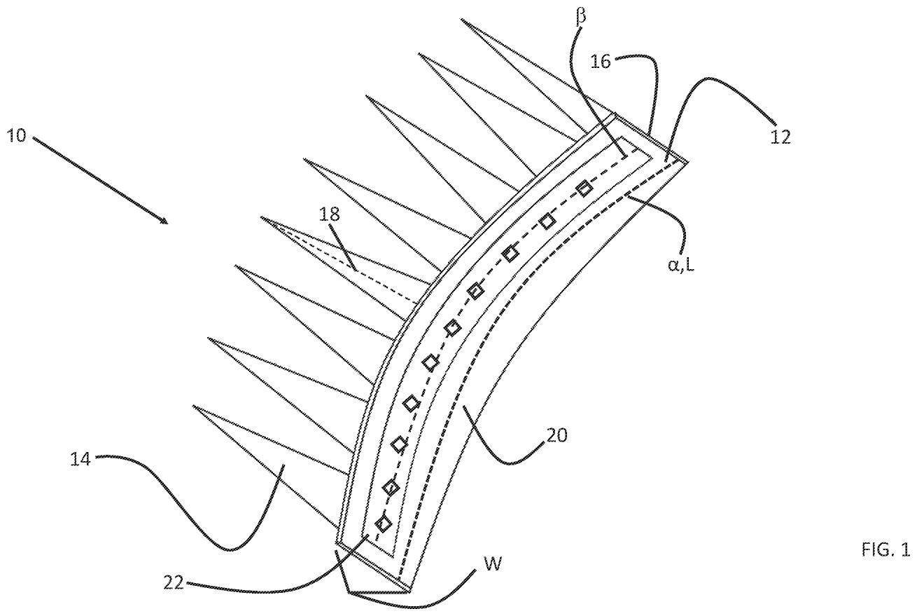

Turning to the figures, FIG. 1 depicts a perspective view of an assembled lash extension system 10. Said lash extension system comprises a lash support strip 12 extending along a longitudinal axis a, wherein the lash support strip 12 has a length L and width W. (The width W is a representation and not drawn to scale and may be narrower.) The lash support strip can be straight or curved to accommodate the eyelid of a user. The support strip may be made using a filament or a lace material and applying glue over it, or just by gluing without filaments or lace materials. Lash filaments 14 extend from a first, laterally facing, surface 16 the lash support strip 12 in a direction substantially perpendicular to the longitudinal axis of the lash support strip 12. FIG. 1 shows the lash extension system as having discrete filaments 14 spaced apart along the longitudinal axis of the lash support strip 12. This is exemplary and not meant to be limiting. A person having ordinary skill in the art will understand that many eyelash extension systems are known having various assortments of eyelash filaments. For example, the system can feature clumps of filaments extending in different directions, crossing one another, but still substantially perpendicular to the longitudinal axis of the lash support strip 12. Further, the protruding portions 18 of the lash filaments 14 from the lash support strip may all be of uniform length or can be of varying lengths.

The lash support strip, as shown in FIG. 1, also features a second, medially facing surface 20 that faces a user when the lash extension system is in use. Said second surface 20 is concave in order to overlay a portion of the eyelid of a user. As shown in FIG. 1, an adhesive element 22 is disposed on the second surface 20 of the lash support strip 12 and extends along its longitudinal axis β that is substantially parallel to and the longitudinal axis a of the lash support strip 12. The first (laterally facing) surface 16 and the second (medially facing) surface 20 may be flat (e.g., like a tape's surface) or curved (e.g., like the surfaces of a wire whose cross-section is round in shape) depending on the shape of the support strip being used.

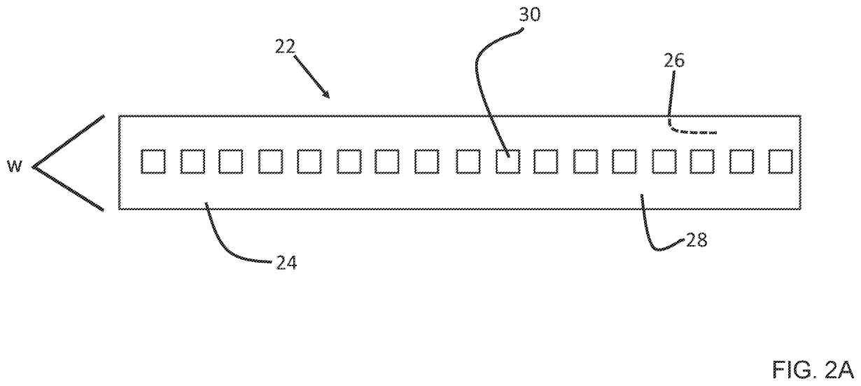

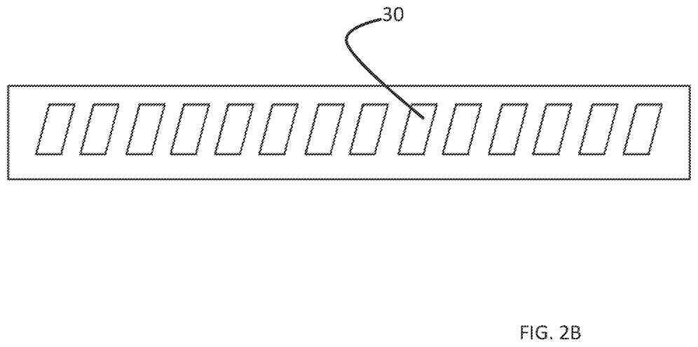

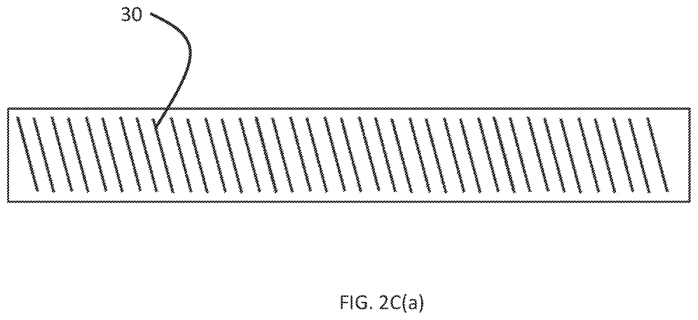

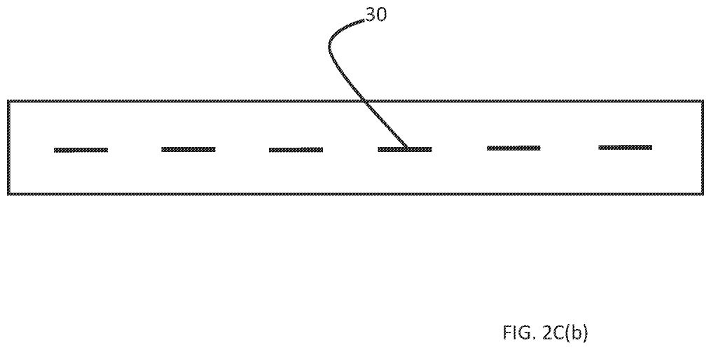

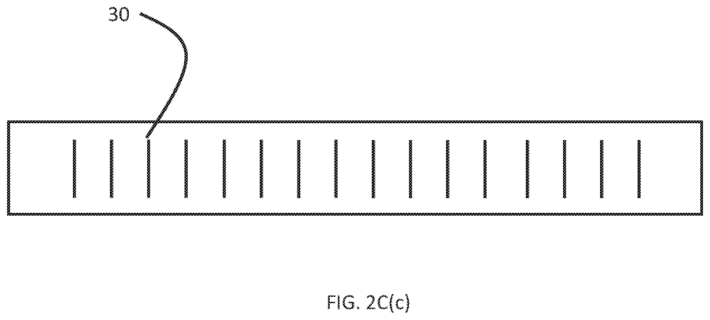

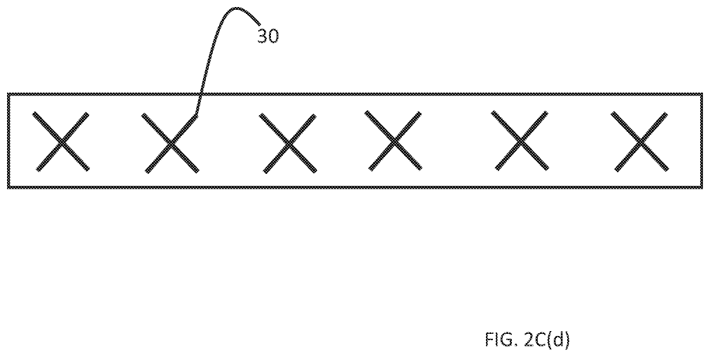

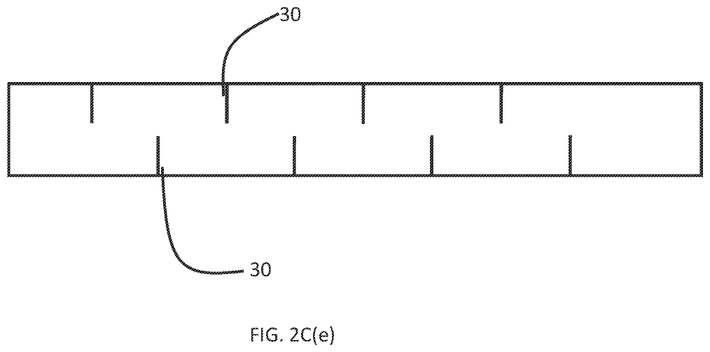

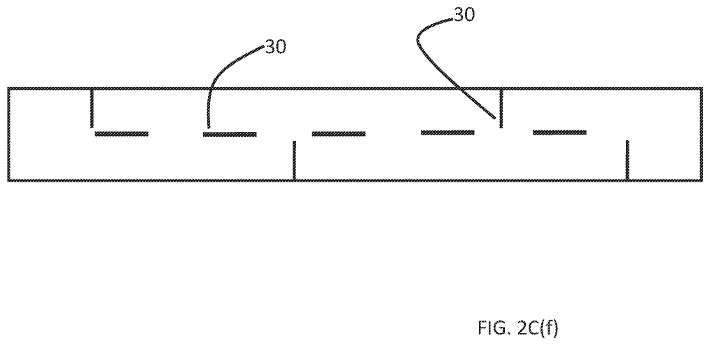

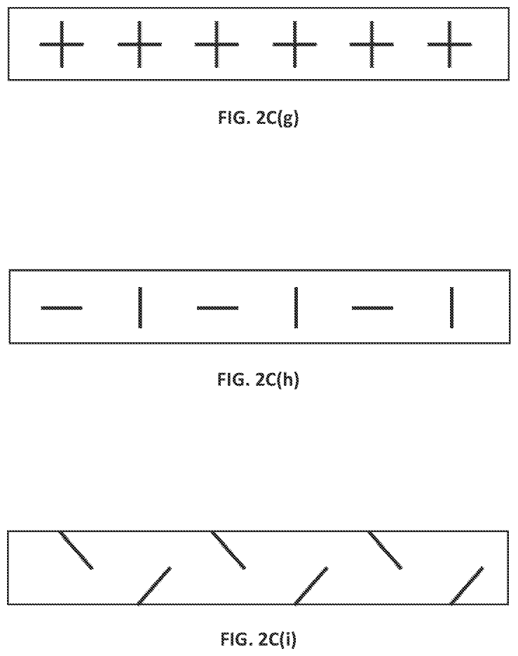

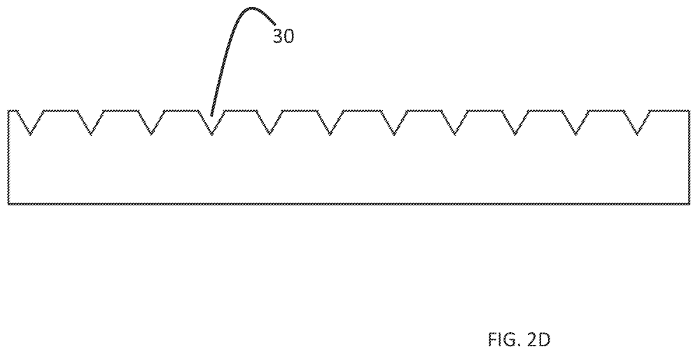

FIG. 2A shows a plan view of an exemplary adhesive element 22. The adhesive element 22 is an elongated substrate 24 featuring a first 26 and second 28 surface. The adhesive element also has a thickness (not shown). The adhesive is disposed on each of the first 26 and second surfaces 28 of the elongated substrate. The adhesive disposed on the first surface 26 may be different from the adhesive disposed on the second surface 28. The length and width of the adhesive element can be adjusted to fit any lash support strip. A typical adhesive element tape has a length between approximately 25 mm and approximately 35 mm, with a typical width of approximately 1 mm or less. The adhesive element may also have a shorter length depending on particular styles of eyelash extension systems, such as smaller “wisp” eyelash extension systems (e.g., KISS Falscara Eyelash made by Kiss Products, Inc. located in Port Washington, NY) that are segmented versions of a full-strip eyelash extension system and whose support strip lengths are one-half to one-fifth of a full-strip eyelash extension system's support strip length. The thickness of the adhesive element tape may be between 0.5 mm and 0.8 mm and preferably between 0.6 mm and 0.7 mm, but it could be less.

A salient feature of the invention is the use of flat, thin adhesive elements, such as a flat tape. State-of-the-art eyelash extension systems utilize bulky adhesive elements such as various tapes that utilize a non-flat core coated in an adhesive. Use of the flat adhesive elements of the instant invention enables the use of adhesive elements having a very thin width (e.g., less than 1 mm as discussed above) as either of the surfaces 26, 28 of the adhesive element can be fully coated with adhesive and provide a large surface to strongly adhere to the desired surface (i.e., user's eyelash, or user's eyelid). Prior art methods using bulky tapes cannot rely on the surface area of their adhesive element to obtain a strong bond between adhesive and eyelash extension or adhesive and eyelid of a user.

In an embodiment of the instant invention, the adhesive elements are sufficiently thin and flat that they can be used without the cutouts shown and discussed infra. Suitable materials for the adhesive tape can include acrylic, urethane, rubber, and silicone. In another embodiment, the adhesive elements have a flat second (user-facing) surface 28 while allowing a first surface 26 of curved shape to accommodate for the shape of the eyelash support strip 12.

Suitable adhesives for use in the instant invention include any pressure-sensitive adhesive that can be applied to the adhesive element and retain stickiness, while the lash extension systems 10 are stored in packaging. The lash-side adhesive disposed on the first surface 26 of the elongated substrate has an adhesion to the second surface 20 of the lash support strip that maintains contact between the adhesive element and the lash support strip through production, packaging, storage, and use of the invented lash extension system. It should have excellent pressure-sensitive adhesive force to plastics, especially polybutylene terephthalate (PBT) and polyethylene terephthalate (PET), which are the main components of artificial eyelash extension systems, and good elasticity during the final combination for ease of application to curved eyelash extension systems. Once disposed on the first surface 26, the adhesive preferably has a thickness of 0.05 mm to 0.4 mm. Suitable components for this adhesive include optimized acrylic, rubber urethane, silicone-based copolymer, stabilizer, dispersant, plasticizer, and solvent.

The skin-side adhesive disposed on the second surface 28 of the elongated substrate preferably adheres less strongly to a contacted surface or object than the adhesive on the adhesive on the first surface 26 of the elongated substrate, but similar or same adhesion strengths can also be acceptable. The adhesive preferably lasts for a number of hours (e.g., 10-12 hours) when attached to the user's skin or eyelashes, is capable of being reused multiple times (e.g., ten times) after being removed, and is harmless to the human body. This feature allows for the manufacture of the invented lash extension system, the usage of a temporary backing over the adhesive element prior to use by a user, and for the lash extension system to easily be removed from the eyelid of a user after use. Suitable adhesives can include adhesives based on one or more of materials such as acrylic, rubber, silicone, polyester, urethane, etc. In order to achieve the desired properties, the pressure-sensitive adhesive binder may use appropriate additives such as a crosslinking agent, a curing agent, a tackifying resin, a plasticizer, a pigment, a dye, a filler, an anti-aging agent, a conductive agent, an antistatic agent, an ultraviolet absorber, a light stabilizer, a peeling regulator, a softener, surfactant, a flame retardant, or an antioxidant.

The skin-side adhesive generally comprises a binder mixed with one or more of the suitable adhesives such as those described above. In one embodiment, the skin-side adhesive comprises, by weight, 50-80% binder, 1-20% crosslinking agent, 1-20% tackifier, 1-10% plasticizer, 1-5% stabilizer, 1-5% dispersant, and 1-5% other additives. In another embodiment, the skin-side adhesive contains a block copolymer (such as silicone-polyurethane) in which two components are combined for the optimization of skin pressure-sensitive adhesion properties. In another embodiment, the skin-side adhesive includes a binder copolymer which has a linear, radial, and multi-arm structure to achieve the desired properties. In another embodiment, the skin-side adhesive includes an acrylic pressure-sensitive adhesive which uses, as a base polymer, an acrylic polymer (homopolymer or copolymer) using one type or two types or more types of (meth)acrylic acid alkyl esters as a monomer component, wherein the (meth)acrylic acid alkyl ester in the acrylic pressure-sensitive adhesive, for example, may include (meth)methyl acrylate, (meth)ethyl acrylate, (meth)acrylic acid propyl, (meth)acrylate isopropyl, (meth)acrylate butyl, (meth)isobutyl acrylate, (meth)acrylic acid s-butyl, (meth)acrylic acid t-butyl, (meth)acrylic acid pentyl, (meth)acrylic acid hexyl, (meth)acrylic acid heptyl, (meth)acrylic acid octyl, (meth)acrylic acid 2-ethylhexyl, (meth) acrylate isooctyl, (meth) acrylate nonyl, (meth) acrylate isononyl, (meth) acrylate decyl, (meth) acrylate isodecyl, (meth) acrylate undecyl, (meth) acrylic acid Dodecyl, (meth)acrylic acid tridecyl, (meth)acrylic acid tetradecyl, (meth)acrylic acid pentadecyl, (meth)acrylic acid hexadecyl, (meth)acrylic acid heptadecyl, (meth)acrylic acid octadecyl, (meth)acrylic acid nona and (meth)acrylic acid alkyl esters having a linear or branched alkyl group having 1 to 20 carbon atoms in the alkyl group, such as (meth)acrylic acid eicosyl.

In another embodiment, the skin-side adhesive includes a rubber-based pressure-sensitive adhesive binder such as polyisoprene rubber, styrene-butadiene (SB) rubber, styrene-isoprene (SI) rubber, styrene-isoprene-styrene block air Synthetic (SIS) rubber, styrene-butadiene-styrene block copolymer (SBS) rubber, styrene-ethylene-butylene-styrene block copolymer (SEBS) rubber, styrene-ethylene-propylene-styrene block copolymer (SEPS) rubber, styrene-ethylene-propylene block copolymer (SEP) rubber, regenerated rubber, butyl rubber, polyisobutylene, or rubber-based binder using modified products thereof as a base polymer.

In another embodiment, the skin-side adhesive includes a silicone-based pressure-sensitive adhesive binder. For example, the silicone resin can be an organopolysiloxane having at least one unit selected from M units (R3SiO1/2), Q units (SiO2), T units (RSiO3/2), and D units (R2SiO), wherein R in each unit is independent of each other, a monovalent hydrocarbon group or a hydroxyl group. A functional group may be introduced into the copolymer as needed, and the introduced functional group may cause a crosslinking reaction. The silicone resin is a called MQ resin, composed of M units and Q units. The peroxide curable silicone resin may include two or more types of silicone resins and may include two or more types of partial condensates of silicone resins. The curing agent can be, for example, benzoyl peroxide, t-butylperoxybenzoate, dicumylperoxide, t-butylcumylperoxide, di-t-butylperoxide, 2,5-Dimethyl-2,5-di(t-butylperoxy)hexane, 2,4-dichlorobenzoyl peroxide, 1,1-bis(t-butylperoxy)-3,3,5-trimethylcyclohexane, 2,5-dimethyl2,5-di(t-butylperoxy)hexyne-3.

In another embodiment, the skin-side adhesive includes a polyester-based pressure-sensitive adhesive binder which comprises at least a polyester obtained by polycondensing a dicarboxylic acid having a side chain and an aliphatic diol having 3 to carbon atoms. The polyester-based pressure-sensitive adhesive binder contains a dicarboxylic acid having a side chain, and polyester obtained by polycondensing diol, polyether polyol, and a crosslinking agent.

In another embodiment, the skin-side adhesive includes a urethane-based pressure-sensitive adhesive binder which has one polyol or more polyols (a-1) excluding polyether polyols having one or more ethyleneoxy (EO) groups in one molecule and at least one polyether polyol (a-2) having one or more ethyleneoxy (EO) groups in one molecule and a urethane prepolymer which is a reaction product of at least one polyisocyanate (b) are included. The urethane-based pressure-sensitive adhesive binder has a β-diketone compound (X) or a fatty acid ester as well.

The tackifying resin used in the skin-side adhesive can include one or more of: saturated hydrocarbon resin (synthetic petroleum resin), rosin ester derivative, terpene-based resin, phenol-based resin, and other polymers expressed tackifying properties.

The plasticizer used in the skin-side adhesive can include one or more of liquid paraffin, hydrogenated oil, hydrogenated castor oil, higher alcohols such as octyldodecanol, squalane, squalene, castor oil, liquid rubber(polybutene), or isopropyl myristate.

Other additives used in the skin-side adhesive can include one or more of such as pigments, dyes, fillers, anti-aging agents, conductive agents, antistatic agents, ultraviolet absorbers, light stabilizers, peel modifiers, softeners, surfactants, flame retardants, or antioxidants. These other additives are not particularly stable and are included when necessary to achieve the desired properties.

A salient feature of the invented lash system is the use of cutouts 30 in the adhesive elements 22 of the invented lash extension system 10. These cutouts or apertures 30 can comprise various shapes or combinations and permeate through the entire thickness (i.e., between the first 26 and second 28 surfaces) of the adhesive element, or partially therethrough. These cutouts provide two substantial benefits. First, the cutouts can provide robustness to the shape of the elongated substrate such that the elongated substrate resists deformation and crumpling when folded or twisted or under various environmental factors (e.g., humidity, temperature) during transport and storage. Also, the cutouts allow for fluid communication between the first and second surfaces of the elongated substrate even when the adhesive element is applied to the lash support strip of the invented lash extension system. This fluid communication allows for air bubbles between the adhesive element and lash support strip to escape through the cutouts when the adhesive element is being applied to the lash support strip. Further, the cutouts can be placed at regular or irregular intervals along the length of the adhesive elements and at any position along the width of the adhesive elements.

FIG. 2A shows the cutouts as rectangles disposed at regular intervals along the length of the adhesive element. The particular rectangles in FIG. 2A are squares. However, this is exemplary and not meant to be limiting as any type of rectangle can be used.

FIGS. 2B-2E depict various embodiments of the adhesive elements usable in the instant invention. FIG. 2B shows an adhesive element featuring cutouts that are diagonally disposed parallelograms apertures 30. FIG. 2C shows an adhesive element featuring cutouts that are slit apertures 30 formed by scoring through the first and/or second surfaces of the elongated substrate. Such slit apertures 30 of FIG. 2C may be oriented in various ways, as shown in FIGS. 2C(a)-2C(i), and any other orientations or combinations thereof. In some embodiments, the apertures 30 comprise narrow slits.

The previous FIGS. generally show the adhesive elements disposed within the bounds of the length and width of the adhesive elements. In other embodiments, the cutouts are on the lateral edges of the adhesive elements. Such an embodiment is shown in FIGS. 2C(e) and 2D with cutouts disposed at the lateral edges of an adhesive element. In configurations such as 2D where the cutouts are larger, it can be beneficial to have a cutout on one lateral edge of the adhesive element with the opposing lateral edge not having a cutout, as shown in FIG. 2D. This pattern can be repeated along the length of an adhesive element so as to provide the benefits of the cutouts discussed above without creating sections of the adhesive element having little tensile strength compared to other designs. Alternatively, there are cutouts on opposing sides of the adhesive element at regular intervals along the length of said adhesive element, as shown in FIG. 2E. Alternatively, there are cutouts on opposing sides of the adhesive element at regular intervals along the length of said adhesive element, with the cutouts on one side laterally offset from cutouts on the other side as shown in FIGS. 2C(e) and 2F. Such a configuration can preserve strength in the adhesive element by increasing the width of the substrate between the cutouts compared to the configuration in FIG. 2E.

A salient feature of this invention is the ready-to-use nature of the system. This means that a user can use the invented system by applying the invented system without taking further steps or adding glue to the lash extension system or their own lashes or eyelids. In order to obtain this feature of the invention, packaged eyelash extension systems must have sticky, clean adhesive elements for application to a user's eyelid or eyelashes. In an embodiment, the invented system is packaged with the second surface of the adhesive element exposed for one-step application. In an alternative embodiment, as mentioned above, the second surface of the adhesive element is overlaid with a temporary backing (a second elongated substrate overlaying the adhesive element). In that configuration, a user can remove the temporary backing prior to attaching the lash extension system to their eyelid or eyelashes.

FIG. 2G shows an alternative adhesive element embodiment 23. As shown in FIG. 2G, the adhesive element 23 is substantially similar to those shown in FIGS. 2A-F. This embodiment shares all the features of the previously shown adhesive elements (and can feature any shape or other cutout configuration discussed supra). This embodiment 23 features a tab 25 extending from one of the edges 27 of the adhesive element. The tab 25 is a small and integral portion of the substrate (same material as the rest of the adhesive element) that does not feature any adhesive spread over either its upwardly or downwardly facing surfaces but may feature adhesive spread on the downwardly facing surface in contact with the rest of the adhesive element 23. FIG. 2G shows the tab as the most lateral portion of the adhesive element 23. This is exemplary and not meant to be limiting. The tab can be disposed at either, or both, of the most lateral portions of the adhesive elements. Further, the tab can extend from either the superior or depending edges 27a, 27b of the adhesive element. The tab 25 provides a non-sticky element for a user to grab either by hand or using a tool such as a tweezer to manipulate an assembled lash extension system.

FIG. 2G shows only one tab extending from the adhesive element. This is exemplary and not meant to be limiting. In alternative embodiments, a plurality of tabs extends from an adhesive element. Also, the tab 25 may have larger dimensions than the rest of the adhesive element 23 so that it is easier to be grabbed by hand. Additionally, each tab may contain one or more apertures along the length of the tabs. These apertures can take various forms, similar to the adhesive element apertures depicted in FIGS. 2A-2F.

Similar to the adhesive element 23 shown in FIG. 2G, any backing elements used to temporarily overlay an adhesive element, can feature the tab element discussed supra.

Manufacturing Detail

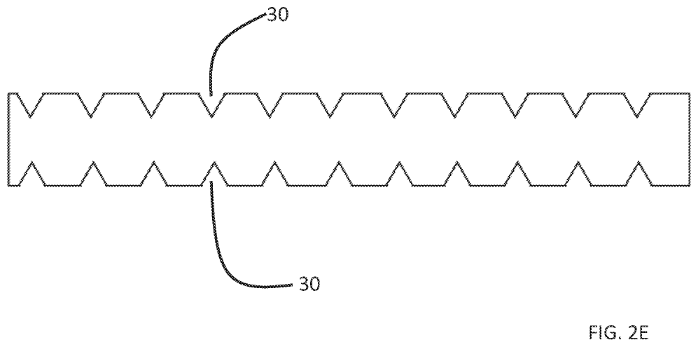

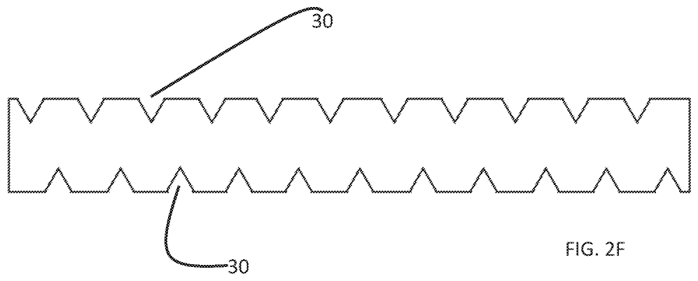

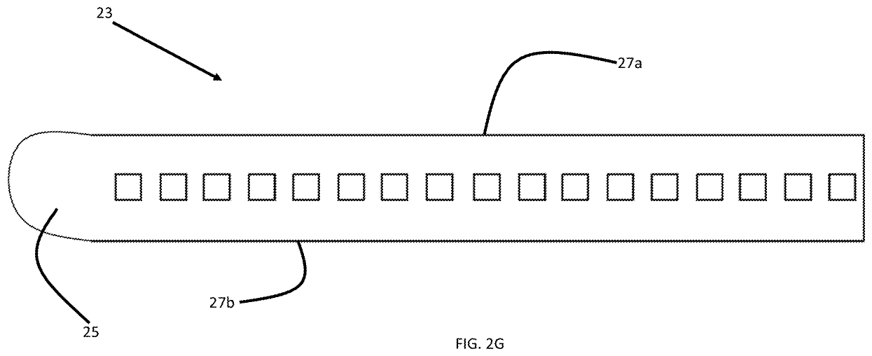

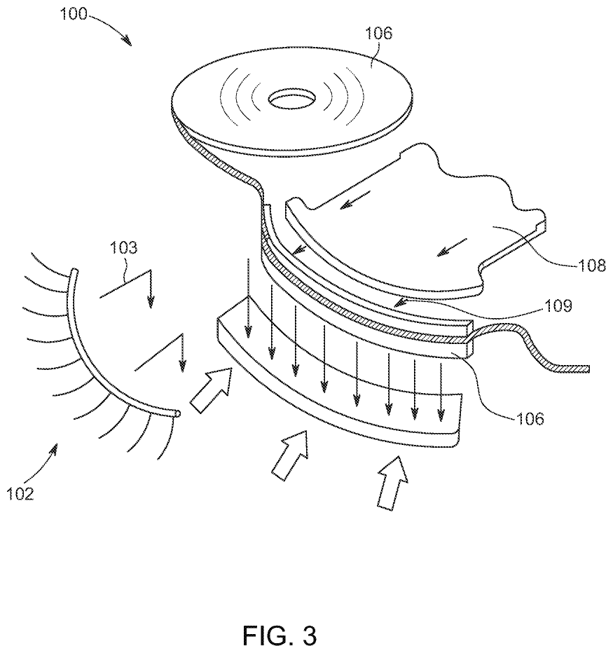

FIG. 3 shows an exploded view of a manufacturing setup 100 to produce the invented eyelash extension systems. As shown in FIG. 3, the method begins with a naked eyelash extension system 102 (one without an adhesive element). In the invented manufacturing method, the eyelash extension system 102 is first moved 103 onto the adhesive application stage, where a tape assembly 106 is then placed adjacent to the eyelash extension system. Once the tape assembly 106 is adjacent to the eyelash extension system, the pushing assembly 108 pushes 109 the adhesive element onto the eyelash extension system 102, thereby attaching the adhesive element to the eyelash extension system. It is to be noted that, although FIG. 3 shows the stage having a flat surface on which the eyelash extension system 102 is placed; there can be other stage configurations (e.g., a stage having a non-flat surface, a curved surface) that allow staging of one or more eyelash extension systems 102 for attaching adhesive elements, such as the tape assembly 106, to them.

As shown in FIG. 3, the invented manufacturing method begins with a lash extension system 102 that does not yet have an associated adhesive element. In the first step of manufacture 103, the naked eyelash extension system is moved onto the adhesive application stage.

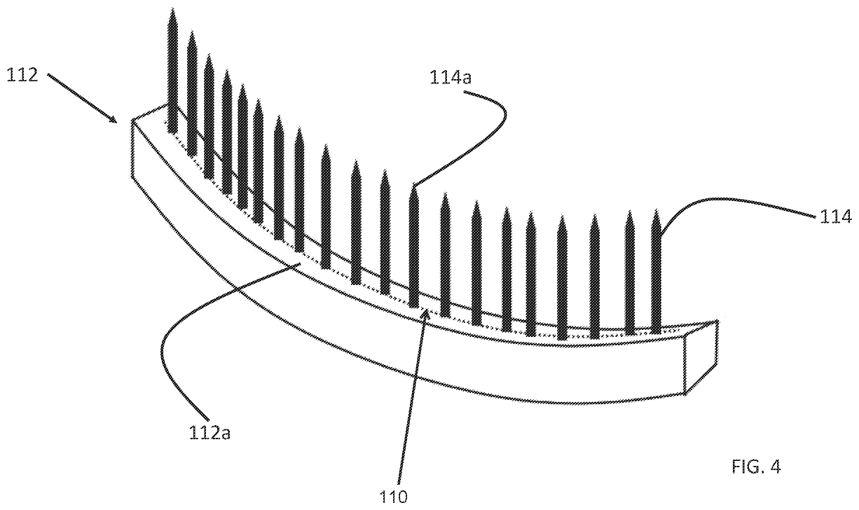

FIG. 4 is a detailed view of an example of the adhesive application stage. The adhesive application stage is a platform 112 that is substantially flat. Said platform has a length and width suitable to accommodate the footprint of one or more lash extension systems 102.

FIG. 4 shows the adhesive application stage as a curved stage. This is exemplary and not meant to be limiting. The adhesive application stage can be any size, shape, area, and dimensions sufficient to accommodate the invented manufacturing process.

As shown in FIG. 4, retaining members 114 extend from the upwardly facing surface 112a of the platform. A plurality of these retaining members 114 extend from the platform 112 of the adhesive application stage in a direction substantially perpendicular to the surface of the platform. Said retaining members are disposed such that they form a semi-circle approximating the curvature of a lash extension system's support strip used with the instant invention. The retaining members 114 are shown in FIG. 4 as having a terminating end 114a that tapers into a point. The pointed terminating end of the retaining members 114 ensures that the retaining members extend between lash filaments or groups thereof and do not bend the filaments. In alternative embodiments, the terminating ends of the retaining members 114 are rounded but not sharp or even flat. In yet other embodiments, the terminating ends of the retaining members 114 extend from another platform opposite to the upwardly facing surface 112a of the platform 112, so the retaining members 114 are flanked by two platforms, one on each end.

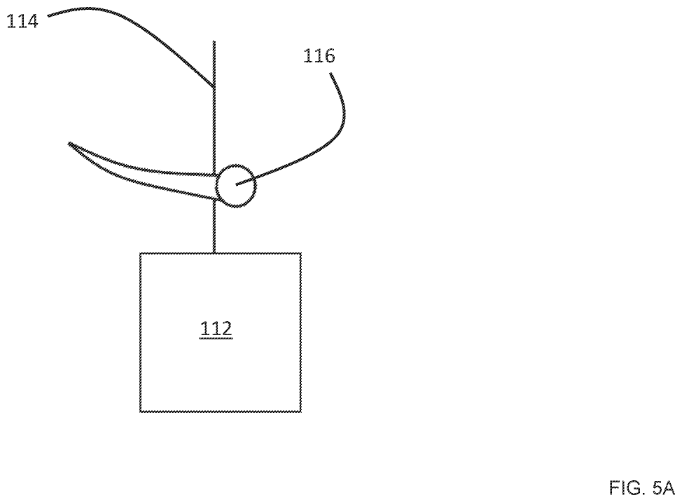

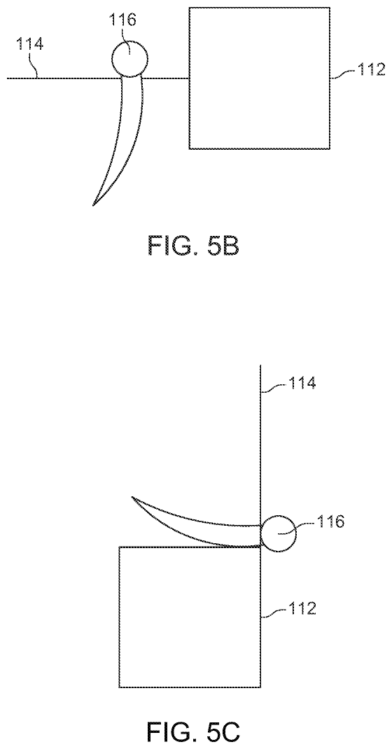

In FIGS. 4 and 5A-C, the retaining members 114 are monoliths extending from the surface of the platform 112 of the adhesive application stage. These monoliths are arranged, as stated above, in a semicircular arrangement that mirrors the curve of a lash support strip 116 of a lash extension system, where each such curved arrangement is approximately the same length or slightly longer than the lash support strip 116. The monoliths 114 are positioned at regular intervals along a line 110 following the curvature of the platform 112. This arraignment allows each monolith to provide equal force when pushing against a lash support strip in order to prevent tearing or deformation of said strip or an adhesive element that will be on the other side of the monoliths from the lash support strip, as shown in FIG. 5A-C.

In one embodiment, the plurality of retaining members 114 is arranged in a curved line to approximate a curvature of the eyelash support strip 112.

The monoliths 114 are shown as cylindrical. This is exemplary and not meant to be limiting. The monoliths can be any shape that will not tear or damage any adhesive elements, or eyelash support strips 116 used in the instant invention.

In the first step of the invented manufacturing method 103, a lash extension system 102 that has not yet received an adhesive element is placed onto the platform 112 of the adhesive application stage. The lash extension system is placed so that the monoliths contact the first surface of the lash support strip 116 of the lash extension system 102. The lash extension system is placed such that the curvature of the lash support strip nests within the curvature of the arraigned monoliths. FIG. 5 shows the monoliths extending between individual lash filaments. In an embodiment, the lash filaments extend in different directions and overlap in groups of lash filaments. In such an embodiment, the monoliths extend between individual filaments in the group but may be in contact with more than one filament.

FIGS. 5A-C are cross-sectional views of the adhesive application stage once the lash extension system is placed on the platform 112. As shown in FIG. 5A, the lash support strip is positioned at some distance from the platform 112. The inventors envision embodiments wherein the lash extension system is suspended some distance over the platform 112. A person having ordinary skill in the art could readily determine how this can be accomplished. For example, in an embodiment, the portion of the monoliths nearest the platform has a section having increased diameter, giving the lash extension system a surface to rest on. The portion of increased diameter of the monoliths can extend a desired length from the platform 112 such that a lash extension system disposed on the increased diameter portion from the monoliths would be the desired distance above the platform 112. This is exemplary and not meant to be limiting. For example, as shown in FIG. 5B, the retaining members 114 may extend horizontally from the platform 112 so that the eyelash support strip 116 rests on the retaining members 114 with the filaments pointing downward. Alternatively, the inventors also envision an embodiment wherein the lash extension system is in contact with and rests on the upwardly facing surface 112a of the platform 112, in which case the retaining members 114 may extend from the edge of the platform 112, as shown in FIG. 5C, depending on a particular embodiment of the invented manufacturing method disclosed herein.

Once the naked lash extension system 112 is positioned on the platform 112, the tape assembly 106 moves 107 into place relative to the lash support strip of the naked lash extension system. Depending on the orientation of the naked lash extension system's position with respect to the platform (e.g., FIGS. 5A and 5B), the tape assembly's direction of movement will be adjusted appropriately (e.g., in the case of FIG. 5B, the tape assembly moves into place above the lash support strip, wherein it moves into place adjacent to the lash support strip in FIG. 5A).

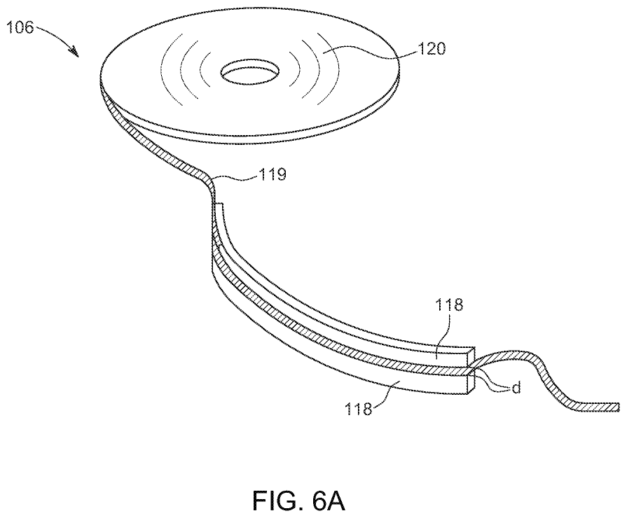

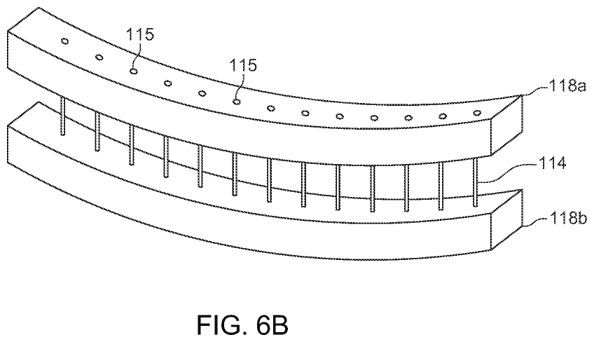

FIG. 6A is a detailed view of the tape assembly 106. As shown in FIG. 6A, the tape assembly comprises two semicircular and horizontally extending rails 118 that are separated a distance d from each other. A length of adhesive element 119 is disposed between the two rails 118 with slack adhesive element 119 pulled from a supply roll 120. The adhesive element disposed between the rails 118 can be an elongated substrate with adhesive disposed on each side. Or, alternatively, the side of the elongated substrate facing away from the naked lash extension system can feature a temporary backing layer. The adhesive element can be any of those shown in FIGS. 2A-E, above. As shown in FIG. 6B, the platform 112 and retaining members 114 may be integrated into the rails 118. One of the rails (e.g., the bottom rail 118b) is a platform 112 with retaining members 114, and the other rail (e.g., the top rail 118a) has holes 115 made vertically in it, wherein the placements of the holes 115 along the length of the top rail 118a correspond to the placements of the retaining members 114 along the length of the bottom rail 118b. The retaining members 114 of the bottom rail 118b are inserted into the holes 115 of the top rail 118a.

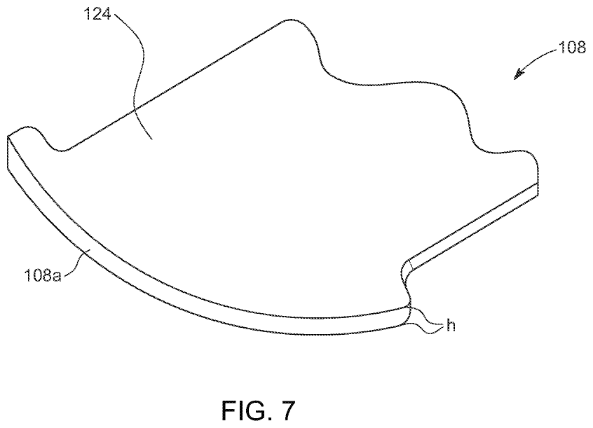

Once the tape assembly 106 is in position with respect to the lash support strip disposed on the adhesive application stage, the pushing assembly is moved into place adjacent to the tape assembly. FIG. 7 is a detailed view of the pushing assembly 108.

As shown in FIG. 7, the pushing assembly comprises a flat plate having a height h that is substantially equal to the width w of the adhesive element 22 or, depending on a particular embodiment of the invented manufacturing method disclosed herein, the height h may be substantially equal to the width w of the support strip 12 (FIG. 1). In another embodiment, the width w of the support strip 12 may be substantially equal to the width w of the adhesive element 22, and the height h is substantially equal to the widths w of both the adhesive element and the support strip. The plate features a proximal end 108a that is semicircular and is substantially equal or similar in size and curvature to the lash support strip of the naked lash extension system.

Once the pushing assembly is in place relative to the tape assembly, the semicircular end 108a of the pushing assembly 108 pushes the adhesive element from between the rails of the tape assembly and onto the second surface of the lash support strip of the naked lash assembly system. The retaining members 114 of the adhesive assembly stage provide a backstop for the force provided by the pushing assembly, allowing for a firm imposition of the adhesive element onto the lash support strip of the naked leash extension system. After the pushing step, the lash extension system can be removed from the adhesive assembly stage, and the system reset for application of an adhesive element onto the next naked lash extension system or the next batch thereof.

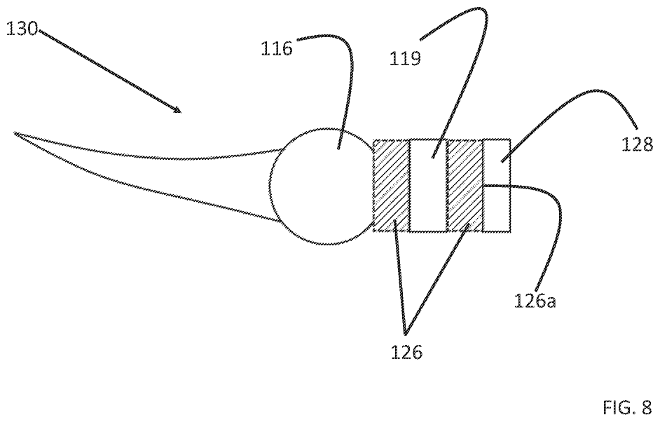

FIG. 8 provides a cross-sectional view of a finished lash extension system 130. As shown in FIG. 8, the lash support strip of the extension system 116 is in receipt of an adhesive element 119 having adhesive 126 on both sides of the element 119. The embodiment of the lash extension system 130, shown in FIG. 8, is also shown with a temporary backing 128 overlaying the adhesive on the user-facing adhesive 126a, as discussed above.

In an alternative embodiment, a complete eyelash extension system is assembled using a conveyor belt system, wherein the naked lash extension 102 is transported along a conveyor belt to a first stopping point. When the lash extension 102 reaches the stopping point, the conveyor belt ceases movement so that the naked lash extension system 102 can be retrieved by a machine, or a human worker alternatively, and the lash support strip 116 of said naked lash extension system 102 placed into contact with an adhesive element 119 so that the adhesive element 119 adheres to the lash support strip 116 to create a finished lash extension system 130. The finished lash extension system 130 is then placed back on the conveyor belt, which begins movement again upon receipt of the finished lash extension system, moving the lash extension 130 to later stations such as packaging. In yet another embodiment, a contiguous strip of support strips 116 (e.g., a length totaling 50 eyelash extension systems) is attached to a contiguous strip of adhesive elements 119 by using the methods disclosed herein, after which the attached combination of the contiguous strips is cut at appropriate places along its length (e.g., 50 places) to create multiple eyelash extension systems (e.g., 50 eyelash extension systems).

A specialized tape assembly 106 is shown and discussed above. In alternative embodiments, individual adhesive elements are die cut from a roll, sheet, or strip prior to application to a lash extension system via the conveyor belt method discussed above or by hand.

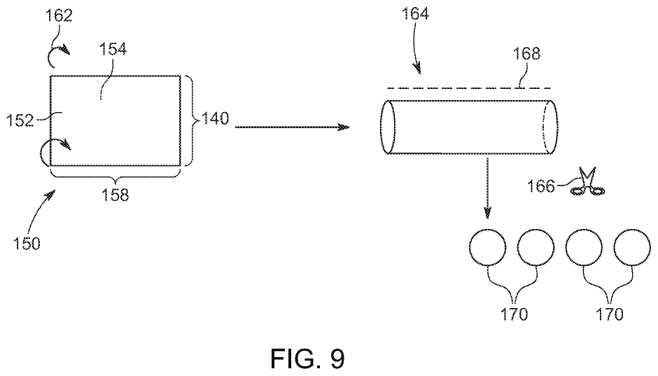

In an alternative embodiment, the adhesive elements are created according to the method shown in FIG. 9. Looking to FIG. 9, a large sheet of substrate 150 of the same material used in making the elongated substrates 24 discussed above, is supplied. Said sheet of substrate 150 has upwardly 152 and downwardly 154 surfaces that are already covered with adhesive (not shown). The sheet of substrate 150 further has a length 158 and a width 140.

The substrate, having already received adhesive on both sides, is rolled 162 into a cylinder 164 along either the width or the length of the substrate 150 depending on the desired dimensions of the cylinder and later adhesive elements to be cut from the cylinder.

Once the cylinder 164 is completed, a cutting implement 166 is used to cut perpendicular to the height 168 of the cylinder to obtain individual circles 170 of substrate 150. These individual circles 170 are a rolled-up, contiguous strip of adhesive elements that can be unrolled, cut at appropriate lengths, and applied to a naked eyelash extension system.

The cutting implement is shown as a pair of scissors. This is exemplary and not meant to be limiting. Any implement suitable for cutting through the rolled-up substrate is suitable and can be automatic or manually run.

FIG. 9 shows the rolling up of the substrate 150 without any internal supporting elements. This allows for circles of rolled-up substrate to easily be cut from the cylinder. Alternatively, the substrate 150 can be rolled around a supporting dolly or spooling element.

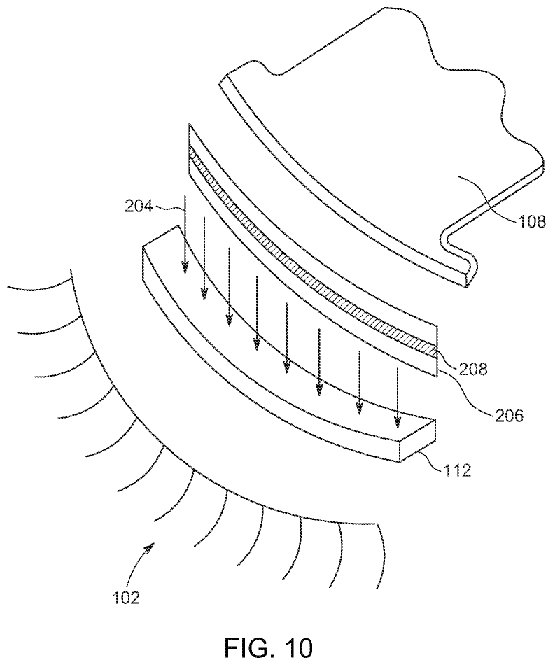

FIGS. 10-12 shows an alternative manufacturing setup to produce the invented eyelash extension systems that uses a release coating and pre-glue application in place of tape.

A release coating 216 is applied to the pre-glue assembly 206, which will prevent the pre-glue from bonding to the adhesive assembly. Once the release coating 216 has cured, pre-glue 212 is applied to the assembly. The eyelash extension system 102 is then moved onto the platform 112 and 118b, and the pre-glue assembly 206 is placed so that the pre-glue 212 faces the support strip of the eyelash extension system. Then the pushing assembly 108 pushes the adhesive element onto the support strip of the eyelash extension system 102.

The method begins with a naked eyelash extension system 200 (one without an adhesive element). This invented manufacturing method uses the platform 112 and 118b of FIGS. 4-6B to accommodate the footprint of a lash extension system 102 as described above. A lash extension system 102 that has not yet received an adhesive element is then placed onto the platform 112 and 118b as described above. Once the naked lash extension system 102 is positioned on the platform 112 and 118b, the pre-glue assembly 206 moves into place relative to the lash support strip of the naked lash extension system.

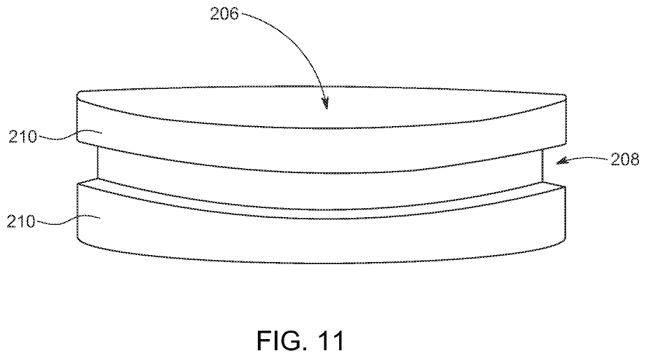

FIG. 11 depicts the pre-glue assembly 206. As shown in FIG. 11, the pre-glue assembly comprises two semicircular and horizontally extending rails 210 that are separated a distance from each other, forming a groove 208 on the pre-glue assembly. A release coating 216 is applied to the groove 208 between the two rails 210. The type of release coating used will depend on the type of pre-glue to be used in the application. For example, the release coating may be silicone-based, fluorine-based, or polyethylene-based. The release coating 216 allows the finished lash extension system 214 to be easily removed from the pre-glue assembly once the lash extension system has been fully assembled. Depending on a particular embodiment of the invented manufacturing method disclosed herein, the pre-glue assembly 206 may have structures that accommodate the retaining members 114 of the platform 112. Such structures may be vertical grooves 202 that extend from the bottom of the lower horizontal rail to through the upper horizontal rail. These vertical grooves 202 align with the retaining members 114 so that the retaining members fit within the vertical grooves.

Once the release coating 216 has been cured, pre-glue 212 is injected into the groove 208 within the pre-glue assembly 106. Alternatively, pre-glue 212 may be applied directly on the second surface of the lash support strip, which may be done by using a nozzle that continuously dispenses the pre-glue along the length of the second surface of the lash support strip. Suitable pre-glues for use in the instant invention include any pressure-sensitive adhesive that can be applied to the adhesive element, retain stickiness while the lash extensions 10 are stored in packaging, and do not bond with the release coating allowing for easy release from the pre-glue assembly 106. The pre-glue assembly 106 is positioned adjacent to the lash support strip disposed on the adhesive application stage. The pushing assembly 108 is then moved into place adjacent to the pre-glue assembly 206.

Once the pushing assembly 108 is in place with respect to the pre-glue assembly 206, the semicircular end of the pushing assembly 108 pushes the pre-glue assembly 206 causing the pre-glue 212 within the groove 208 of the pre-glue assembly to be applied to the second surface of the lash support strip of the naked lash assembly system 102. The retaining members 114 of the adhesive assembly stage provide a backstop for the force provided by the pushing assembly, allowing for a firm imposition of the pre-glue 212 onto the lash support strip of the naked leash extension system 102. After the pushing step, the lash extension system 214 is complete and can be removed from the adhesive assembly stage and the system reset for the application of pre-glue 212 onto the next naked lash extension system 102. In embodiments where the pre-glue assembly has vertical grooves 202 to accommodate the retraining members 114, the pre-glue assembly 106 is pushed to a point where the second surface of the lash support strip enters the horizontal groove 208 of the pre-glue assembly 206, ensuring adequate application of the pre-glue 212 to the lash support strip.

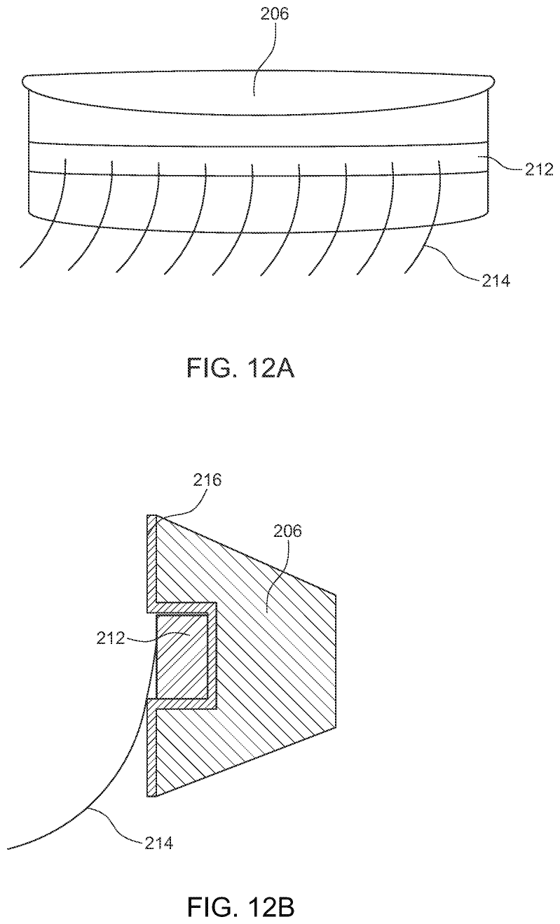

FIG. 12a provides a front-facing view and FIG. 12b provides a cross-section view of a finished lash extension system 214 using the pre-glue manufacturing method. As shown in FIG. 12b, the lash support strip of the extension system 214 is in receipt of a pre-glue 212 on the second (medially facing) surface of the lash support strip. The cured release coating 216 is disposed between the pre-glue 212 and the pre-glue assembly 206, allowing the lash support strip to be easily removed from the pre-glue assembly. The groove 208 of pre-glue assembly has a depth between 0.05 mm and 0.8 mm, but the depth may be deeper or shallower depending on a particular embodiment of the manufacturing method disclosed herein.

The pressure-sensitive adhesive and pressure-sensitive adhesive tape have resistance to pollution by contaminants such as moisture and oil penetrating from the outside in attaching the artificial lash extension systems and can safely attach and detach the artificial lash extension systems. Ideally, the adhesive will have a holding/retention force of multiple hours (e.g., 10-12 hours) when attaching it to the wearer's body (e.g., skin, eyelashes), and can be reused multiple times (e.g., 10 times) after removal.

The pressure-sensitive adhesive and adhesive tape for achieving this objective include adhesive components having excellent properties in adhesion to a substrate with low surface energy. For example, the surface energy of the following substrates is approximately as follows: human skin 25-30 dyne/cm², Polybutylene terephthalate (PBT) 32 dyne/cm², and Polyethylene terephthalate (PET)—42 dyne/cm².

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

It is to be understood that the above description is intended to be illustrative and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

The embodiment of the invention in which an exclusive property or privilege is claimed is defined as follows:

1. A method of manufacturing an eyelash extension system comprising:
providing one or more naked eyelash extension systems onto a stage,
wherein the naked eyelash extension system comprises eyelash filaments extending from a first surface of an eyelash support strip, and wherein the stage comprises a plurality of retaining members; and
attaching an adhesive element from a tape assembly to a second surface of the eyelash support strip, wherein the eyelash support strip is held in place by the retaining members during the attaching step.

2. The method of claim 1 wherein the attaching step comprises pushing the adhesive element onto the second facing surface using a pushing plate.

3. The method of claim 1 wherein the adhesive element has a thickness of 0.5 to mm.

4. The method of claim 1 wherein the attaching step comprises pushing the naked eyelash extension system onto the adhesive element using the plurality of retaining members.

5. The method of claim 1 wherein the plurality of retaining members is arranged in a curved line to approximate a curvature of the eyelash support strip.

6. The method of claim 1 wherein the tape assembly comprises an adhesive element held between two horizontally extending rails.

7. The method of claim 2 wherein the pushing plate comprises a plate having a proximal end that approximates a curvature of the eyelash support strip, and
wherein the pushing step comprises pushing the adhesive element through the tape assembly and onto the second surface of the eyelash support strip of the naked eyelash extension system with the proximal end of the pushing plate.

8. The method of claim 1 wherein the adhesive element is an elongated substrate having a first and a second surface, and wherein an adhesive is disposed on each of the first and second surface.

9. The method of claim 8 wherein the adhesive element has one or more apertures along a length of the elongated substrate.

10. The method of claim 9 wherein the one or more apertures are rectangular shaped.

11. The method of claim 9 wherein the one or more apertures are diagonal parallelogram.

12. The method of claim 9 wherein the one or more apertures are narrow slits formed by scoring the adhesive element.

13. The method of claim 9 wherein the apertures are triangular shaped voids missing from one lateral edge of the elongated substrate.

14. The method of claim 9 wherein the apertures are triangular shaped voids missing from both lateral edges of the elongated substrate.

15. The method of claim 9 wherein the apertures along one lateral edge of the elongated substrate are offset from the apertures along the other lateral edge of the elongated substrate.

16. A method of manufacturing an eyelash extension system comprising:
providing one or more naked eyelash extension systems onto a stage,
wherein the naked eyelash extension system comprises eyelash filaments extending from a first surface of an eyelash support strip; and
applying and curing a release coating to a pre-glue assembly having a groove;
attaching a pre-glue onto a second surface of the eyelash support strip,
wherein the eyelash support strip is held in place by a plurality of retaining elements.

17. The method of claim 16 wherein the attaching step comprises applying the pre-glue to the groove of the pre-glue assembly and pushing the pre-glue assembly towards the stage.

18. The method of claim 16 wherein the attaching step comprises pushing the naked eyelash extension system onto the pre-glue assembly using the plurality of retaining members.

19. The method of claim 16 wherein the plurality of retaining elements is arranged in a curved line to approximate a curvature of the eyelash support strips.

20. The method of claim 16 wherein the pre-glue comprises an adhesive element disposed between two horizontally extending rails.

21. The method of claim 17 wherein the pre-glue assembly comprises a pushing plate having a proximal end that approximates a curvature of the eyelash support strip, and wherein the pushing step comprises pushing the pre-glue onto the second surface of the eyelash support strip through the pre-glue assembly with the proximal end of the pushing plate.

22. The method of claim 16 wherein the attaching step comprises applying the pre-glue to a second surface of the support strip and pushing the pre-glue assembly towards the stage.

23. An eyelash extension system comprising:
an eyelash support strip having a first surface and a second surface;
an adhesive element fixed to the second surface.

24. The system of claim 23 wherein a temporary backing layer is overlaid onto the adhesive element fixed to the second surface of the eyelash support strip.

25. The system of claim 24 wherein the temporary backing layer has one or more tabs.

26. The system of claim 23 wherein the adhesive elements have one or more cutouts formed therethrough.
